(19) United States
(12) Patent Application Publication
(10) Pub. No.: US 2020/0339128 A1
(43) Pub. Date: Oct. 29, 2020

(54) VEHICLE CONTROL APPARATUS

(71) Applicant: HONDA MOTOR CO., LTD., Tokyo (JP)

(72) Inventors: Tadahiko KANOH, Wako-shi (JP); Hiroaki HORII, Wako-shi (JP)

(21) Appl. No.: 16/926,292

(22) Filed: Jul. 10, 2020

Related U.S. Application Data
(63) Continuation of application No. PCT/JP2018/001332, filed on Jan. 18, 2018.

(51) Int. Cl. B60W 30/18; B60W 30/09; B60W 30/12

(52) U.S. Cl. CPC B60W 30/18163; B60W 30/12; B60W 30/09

(57) ABSTRACT

A vehicle control apparatus is provided. The apparatus does not suppress the lateral control in a case in which each of detection levels of both the lateral side and the rear side has reached a predetermined level, and suppresses the lateral control, which is accompanied by the steering control, in a case in which the detection level of at least one of the lateral side and the rear side has not reached the predetermined level, and wherein the lateral control includes a driver lane change in which the vehicle controller subjectively performs the travel control including the steering control based on a request from a driver, and a system lane change in which the vehicle control unit subjectively performs the travel control including the steering control based on a request from the vehicle control unit.

### CROSS-REFERENCE TO RELATED APPLICATION(S)

This application is a continuation of International Patent Application No. PCT/JP2018/001332 filed on Jan. 18, 2018, the entire disclosures of which is incorporated herein by reference.

### TECHNICAL FIELD

The present invention relates to a vehicle control apparatus for performing, for example, automated driving and driving support of an automobile.

### BACKGROUND ART

In automated driving or driving support of a vehicle such as a four-wheeled vehicle, sensors monitor a specific direction or all of the directions of the vehicle to control the automated driving of the vehicle or support the driving operation by a driver based on appropriate path and an appropriate speed in accordance with the monitoring result. In such an arrangement, it proposed that acceleration/deceleration control and steering control will be permitted in a case in which all of the sensors are operating normally, steering control will be prohibited and acceleration/deceleration control will be permitted in a case in which only the front camera cannot normally recognize a lane marker, and

acceleration/deceleration control and steering control will be prohibited in a case other than these cases (see PTL 1). In addition, it is proposed that a required detection distance for a lane change operation of the self-vehicle will be obtained and the driver will be notified that a lane change cannot be performed in a case in which the detectable limit distance of each sensor is shorter than the required detection distance (see PTL 2).

### CITATION LIST

### Patent Literature

PTL 1: Japanese Patent Laid-Open No. 2009-274594 (paragraph 0086, FIG. 16)

PTL 2: Japanese Patent Laid-Open No. 2016-126360 (paragraphs 0038-0039)

### SUMMARY OF INVENTION

### Technical Problem

However, driving control is restricted excessively in the above-described related art. Thus, there is a need to implement safe driving control or driving support while further increasing the automation rate of the driving control or the driving support.

In consideration to the above-described related art, an object of the present invention is to provide a vehicle control apparatus that can implement safe driving control or driving support while further increasing the automation rate of the driving control or the driving support.

### Solution to Problem

The present invention includes the following arrangement in order to achieve the object described above.

That is, according to an aspect of the present invention, there is provided a vehicle control apparatus for controlling a vehicle, comprising: a periphery monitoring unit for performing periphery monitoring of the vehicle; and a vehicle control unit for performing travel control including steering control based on an output from the periphery monitoring unit, wherein the periphery monitoring unit can detect a target on each of a lateral side and a rear side of the vehicle, and the vehicle control unit does not suppress the lateral control in a case in which each of detection levels of both the lateral side and the rear side has reached a predetermined level, and suppresses the lateral control, which is accompanied by the steering control, in a case in which the detection level of at least one of the lateral side and the rear side has not reached the predetermined level, and wherein the lateral control includes a driver lane change in which the vehicle control unit subjectively performs the travel control including the steering control based on a request from a driver, and a system lane change in which the vehicle control unit subjectively performs the travel control including the steering control based on a request from the vehicle control unit, and in a case in which each of the detection levels of both the lateral side and the rear side of the periphery monitoring unit is not less than the predetermined level, the system lane change and the driver lane change are not suppressed, and in a case in which each of the detection levels of both the lateral side and the rear side of the periphery monitoring unit is lower than the predetermined detection level, the system lane change is suppressed, but the driver lane change is not suppressed.

### Advantageous Effects of Invention

According to the present invention, it is possible to implement safe driving control or driving support while further increasing the automation rate of the driving control or the driving support.

Other features and advantages of the present invention will become apparent from the description provided hereinafter with reference to the accompanying drawings. Note that the same reference numerals denote the same or similar components in the accompanying drawings.

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 is a view showing the arrangement of a vehicle system of an automated driving vehicle according to an embodiment;

FIG. 2A is a view showing an example of a detection range of the automated driving vehicle according to the embodiment;

FIG. 2B is a view showing an example of a local map of the automated driving vehicle according to the embodiment;

FIG. 3 is a block diagram for automated driving control;

FIG. 4 is a schematic view showing an example of action candidates under several states;

FIG. 5 is a flowchart showing the procedure of action candidate determination and path selection;

FIG. 6 is a flowchart showing the procedure of path selection in a case in which a driver has made a lane change instruction; and

FIG. 7 is a flowchart showing the procedure when a driving mode (driving level) is changed in the automated driving vehicle.

### DESCRIPTION OF EMBODIMENTS

### First Embodiment

### Outline of Automated Driving and Travel Support

A schematic example of automated driving will be described next. In automated driving, a driver sets, before traveling, a destination via a navigation system incorporated in a vehicle to determine a path to the destination by a server or the navigation system. When the vehicle starts to travel, a vehicle control apparatus (or a driving control apparatus) that has been formed by ECUs and the like included in the vehicle will drive the vehicle to the destination along the determined path. During this period, an appropriate action is determined at an appropriate time in accordance with the external environment such as the path, the state of the road, or the like, the state of the driver, and the like, and the vehicle is made to travel by performing drive control, steering control, braking control, and the like for this action. These control operations may be generally referred to as travel control.

There are several levels of automated driving in accordance with the automation rate (or the amount of tasks request to the driver). For example, at the highest level, the driver may direct his/her attention to something other than driving. This level of automated driving is performed, for example, in a case in which control can be performed comparatively easily such as when the vehicle is following a preceding vehicle on a congested expressway or the like. Also, at a level immediately below the highest level, the driver need not grip the steering wheel, but needs to pay attention to the state of the periphery and the like. This level of automated driving may be applied to, for example, a case in which the vehicle is to travel while maintaining the lane on an expressway or the like. This level may also be referred to as a second mode in this example. Note that the fact that the driver is paying attention to the periphery can be detected by a driver state detection camera 41a, and the fact that the driver is gripping the steering wheel can be detected by the steering wheel grip sensor. In addition, at a level immediately below this level, the driver need not operate the steering wheel or the throttle, but needs to grip the steering wheel and pay attention to the driving in anticipation of a driver takeover operation. This level of automated driving may be applied to diverging and merging on the expressway. This level may also be referred to as a first mode in this example. Furthermore, at a level immediately below this level, the automation rate is further reduced. Although the lowest level is manual driving, it is included as a level of automated driving in this example because it may include partially automated driving support.

The driving support described above has functions to support the driving operation of the driver, who is to be the main subject of driving, by periphery monitoring and partial automation. For example, there are an automatic braking function for monitoring only the front of the vehicle and braking when an obstacle has been detected, a rear monitoring function that detects a vehicle in the right-rear side of the self-vehicle and prompts the driver to pay attention, a function to park the vehicle in a parking space, and the like.

Note that the driver may intervene even if automated driving is being executed. For example, if the driver makes a steering operation or a braking operation during automated driving, the automated driving level may be lowered to the level of driving support so that the driving operation by the driver will be prioritized. In such a case, automated driving may be continued by resetting the automated driving level in correspondence with the state of the self-vehicle and the external environment after the driver has stopped the operation. For example, an example of a steering operation according to this embodiment is a turn signal lever operation that is performed when the vehicle, which has been set to automated driving of an automation rate equal to or higher than the above-described first mode, is traveling on an expressway. If the driver performs, for example, a turn signal lever operation in such a state, the vehicle will determine that a lane change instruction has been made and will make a lane change to a lane on the instructed side. In this case, a travel control unit, which is formed by ECUs and the like, will perform control operations such as steering, braking, driving, and the like while monitoring for obstacles and the like in the periphery of the vehicle.

When the automated driving level (or mode) is to be switched, the driver is notified of this switching from the vehicle by voice, display, vibration, or the like. For example, in a case in which the automated driving is to be switched from the first mode to the second mode, the driver will be notified that the steering wheel may be released. In the opposite case, the driver will be notified that the steering wheel needs to be gripped. This notification is repeated until the steering wheel grip sensor detects that the driver has gripped the steering wheel. Subsequently, for example, if the steering wheel is not gripped until a time limit or a mode switching limit point, an operation to make the vehicle stop at a safe place or the like may be performed. Automated driving is performed generally in the above-described manner, and the arrangements and the control operations for this will be described below.

### Arrangement of Vehicle Control Apparatus

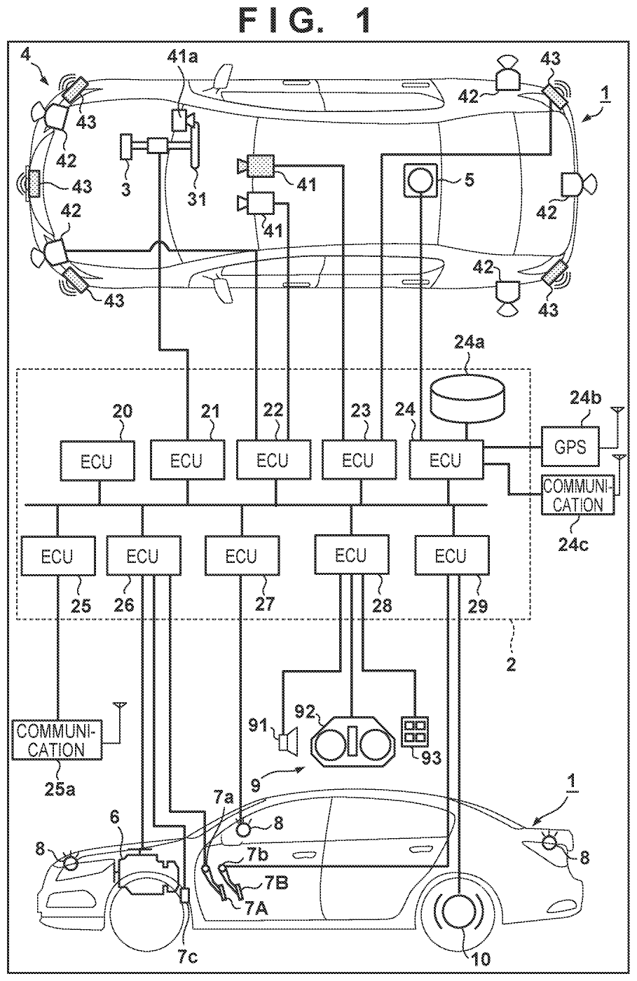

FIG. 1 is a block diagram of a vehicle control apparatus according to an embodiment of the present invention and controls a vehicle 1. FIG. 1 shows the outline of the vehicle 1 by a plan view and a side view. The vehicle 1 is, for example, a sedan-type four-wheeled vehicle.

The control apparatus of FIG. 1 includes a control unit 2. The control unit 2 includes a plurality of ECUs 20 to 29 communicably connected by an in-vehicle network. Each ECU includes a processor represented by a CPU (Central Processing Unit), a storage device such as a semiconductor memory, an interface with an external device, and the like. The storage device stores programs to be executed by the processor, data to be used by the processor for processing, and the like. Each ECU may include a plurality of processors, storage devices, and interfaces.

The functions and the like provided by the ECUs 20 to 29 will be described below. Note that the number of ECUs and the provided functions can be appropriately designed according to the vehicle 1, and they can be subdivided or integrated as compared to this embodiment.

The ECU 20 executes control associated with automated driving of the vehicle 1. In automated driving, at least one of steering and acceleration/deceleration of the vehicle 1 is automatically controlled. In the control example to be described later, both the steering and the acceleration/deceleration are automatically controlled.

The ECU 21 controls an electric power steering device 3. The electric power steering device 3 includes a mechanism that steers front wheels in accordance with a driving operation (steering operation) of the driver on a steering wheel 31. In addition, the electric power steering device 3 includes a motor that generates a driving force to assist the steering operation or automatically steer the front wheels, and a sensor that detects the steering angle. If the driving state of the vehicle 1 is automated driving or driving support, the ECU 21 automatically controls the electric power steering device 3 in correspondence with an instruction from the ECU 20 and controls the direction of travel of the vehicle 1.

The ECUs 22 and 23 perform control of detection units 41 to 43 that detect the peripheral state of the vehicle and information processing of detection results. Each detection unit 41 is a camera (to be sometimes referred to as the camera 41 hereinafter) that captures the front side of the vehicle 1. In this embodiment, two cameras are arranged at the front portion of the roof of the vehicle 1. When images captured by the cameras 41 are analyzed, the contour of a target or a division line (a white line or the like) of a lane on a road can be extracted. The detection unit 41a (to be sometimes referred to as the driver state detection camera 41a hereinafter) is a camera for detecting the state of the driver, is installed to capture the expression of the driver, and although not shown, is connected to an ECU that is to process the image data. In addition, a steering wheel grip sensor (not shown) is included as a sensor for detecting the state of the driver. As a result, whether the driver is gripping the steering wheel can be detected.

The detection unit 42 is a LiDAR (Light Detection and Ranging or Laser Imaging Detection and Ranging) (to be sometimes referred to as the LiDAR 42 hereinafter), and detects a target around the vehicle 1 or measures the distance to a target. In this embodiment, five LiDARs 42 are provided; one at each corner of the front portion of the vehicle 1, one at the center of the rear portion, and one on each side of the rear portion. The detection unit 43 is a millimeter wave radar (to be sometimes referred to as the radar 43 hereinafter), and detects a target around the vehicle 1 or measures the distance to a target. In this embodiment, five radars 43 are provided; one at the center of the front portion of the vehicle 1, one at each corner of the front portion, and one at each corner of the rear portion.

The ECU 22 performs control of one camera 41 and each LiDAR 42 and information processing of detection results. The ECU 23 performs control of the other camera 41 and each radar 43 and information processing of detection results. Since two sets of devices that detect the peripheral state of the vehicle are provided, the reliability of detection results can be improved. In addition, since detection units of different types such as cameras, LiDARs, and radars are provided, the peripheral environment of the vehicle can be analyzed multilaterally.

The ECU 24 performs control of a gyro sensor 5, a GPS sensor 24b, and a communication device 24c and information processing of detection results or communication results. The gyro sensor 5 detects a rotary motion of the vehicle 1. The course of the vehicle 1 can be determined based on the detection result of the gyro sensor 5, the wheel speed, or the like. The GPS sensor 24b detects the current position of the vehicle 1. The communication device 24c performs wireless communication with a server that provides map information and traffic information and acquires these pieces of information. The ECU 24 can access a map information database 24a formed in the storage device. The ECU 24 searches for a route from the current position to the destination.

The ECU 25 includes a communication device 25a for inter-vehicle communication. The communication device 25a performs wireless communication with another vehicle in the periphery and performs information exchange between the vehicles.

The ECU 26 controls a power plant 6. The power plant 6 is a mechanism that outputs a driving force to rotate the driving wheels of the vehicle 1 and includes, for example, an engine and a transmission. The ECU 26, for example, controls the output of the engine in correspondence with a driving operation (accelerator operation or acceleration operation) of the driver detected by an operation detection sensor 7a provided on an accelerator pedal 7A, or switches the gear ratio of the transmission based on information such as a vehicle speed detected by a vehicle speed sensor 7c. If the driving state of the vehicle 1 is automated driving, the ECU 26 automatically controls the power plant 6 in correspondence with an instruction from the ECU 20 and controls the acceleration/deceleration of the vehicle 1.

The ECU 27 controls lighting devices (headlights, taillights, and the like) including direction indicators 8. In the example shown in FIG. 1, the direction indicators 8 are provided in the front portion, door mirrors, and the rear portion of the vehicle 1.

The ECU 28 controls an input/output device 9. The input/output device 9 outputs information to the driver and accepts input of information from the driver. A voice output device 91 notifies the driver of the information by voice. A display device 92 notifies the driver of information by displaying an image. The display device 92 is arranged, for example, in the front of the driver's seat and constitutes an instrument panel or the like. Note that although a voice and display have been exemplified here, the driver may be notified of information using a vibration or light. Alternatively, the driver may be notified of information by a combination of some of the voice, display, vibration, and light. Furthermore, the combination or the notification form may be changed in accordance with the level (for example, the degree of urgency) of information of which the driver is to be notified. An input device 93 is a switch group that is arranged at a position where the driver can perform an operation, is used to issue an instruction to the vehicle 1, and may also include a voice input device.

The ECU 29 controls a brake device 10 and a parking brake (not shown). The brake device 10 is, for example, a disc brake device which is provided for each wheel of the vehicle 1 and decelerates or stops the vehicle 1 by applying a resistance to the rotation of the wheel. The ECU 29, for example, controls the operation of the brake device 10 in correspondence with a driving operation (brake operation) of the driver detected by an operation detection sensor 7b provided on a brake pedal 7B. If the driving state of the vehicle 1 is automated driving or driving support, the ECU 29 automatically controls the brake device 10 in correspondence with an instruction from the ECU 20 and controls deceleration and stopping of the vehicle 1. The brake device 10 or the parking brake can also be operated to maintain the stopped state of the vehicle 1. In addition, if the transmission of the power plant 6 includes a parking lock mechanism, it can be operated to maintain the stopped state of the vehicle 1.

### Periphery Monitoring Device

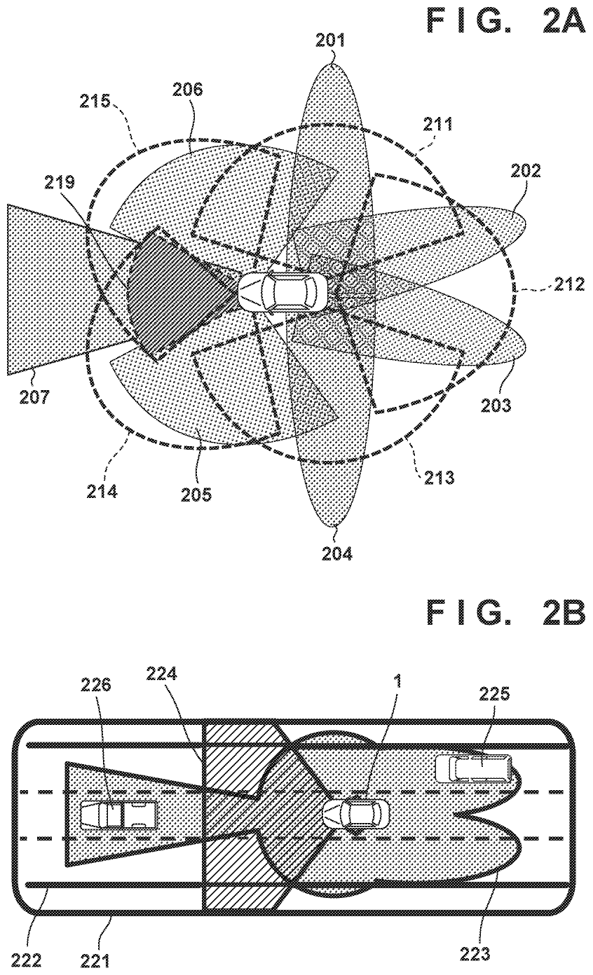

The cameras 41, the LiDARs 42, and the radars 43 shown in FIG. 1 form a periphery monitoring device that detects a target or the like around the vehicle. FIG. 2A shows an example of the range detected by the periphery monitoring duty. In FIG. 2A, regions 201, 202, 203, 204, 205, 206, 207, and the like indicated by halftone dots show the detection range of the radars 43. In particular, the region 201 is a region on the right side, the region 204 is a region on the left side, the region 202 is a region on the right rear side, and the region 203 is a region on the left rear side of the vehicle 1. In addition, the region 205 is a region on the left front side and the region 206 is a region on the right front side. The corresponding radars 43 detect targets such as an obstacle, a vehicle, and the like in their respective regions and measure the distances to the targets. The radars 43 can detect, for example, a vehicle traveling in the right rear side of the self-vehicle, a passing vehicle on the right lane, and the like. Regions 211, 212, 213, 214, and 215 and the like encircled by dotted lines show the detection ranges of the LiDARs 42. In particular, the region 211 is region on the right side of the vehicle 1, the region 213 is a region on the left side of the vehicle 1, and the region 212 is a region on the rear side of the vehicle. The region 214 is a region on the left front side and the region 215 is a region on the right front side of the vehicle 1. The corresponding LiDARs 42 detect targets such as an obstacle, a vehicle, and the like in their respective regions and measure the distances to the targets. The LiDARs 42 can detect, for example, a vehicle traveling in the right rear side of the self-vehicle, a passing vehicle on the right lane, and the like. A region 219 indicated by diagonal lines show the detection ranges of the cameras 41. Although two cameras 41 are arranged in this example, only one of the cameras has been shown since substantially overlapping regions are set as the detection ranges. The image captured by each camera 41 undergoes image recognition so that, for example, a reference such as white lines or the like which indicate the travel lane can be specified from the captured image and be referred for a lane maintenance operation or a lane change operation.

Since the detection ranges of the different sensors overlap in this manner, the redundancy of the sensors is implemented. This will further increase the reliability and allow a detection level to be specified by comparing the detection results of different sensors that have the same region as the detection range. The detection level includes, for example, a detectable distance, a detectable range, and the like. For example, assume a case in which there is a target that is detected by one sensor but is not detected by another sensor when the same region is detected by two types of sensors, that is, the LiDAR 42 and the radar 43. In this case, the latter sensor can be compared with the former sensor to estimate whether the detection distance is short or the detection range is narrow.

Alternatively, for example, only one type of sensor among the LiDAR 42 and the radar 43 can be used to detect a continuous target such as a guardrail and estimate the detection distance based on the detectable distance. Alternatively, the output signal or the like of the sensor can be monitored by a self-diagnosis circuit (not shown), and a failure in the sensor itself can be known based on the monitoring result. In this case, it may be assumed that the detection distance and the detection range of the sensor are not present. The detection level of each sensor, that is, the periphery monitoring device, can be known or estimated in this manner.

### Local Map

FIG. 2B shows a local map according to the embodiment. A local map is map information formed by pieces of information indicating a predetermined range of the vehicle, targets such as obstacles and the like, lanes, and the like about the self-vehicle. Although visually shown in FIG. 2B, the local map may be in a format suited for information processing in practice and include, for example, information indicating the position, the range, and the distance of a target, information indicating the boundary of the road and the lane, and the like. The local map is, for example, periodically updated in accordance with the travel of the vehicle. The update interval suffices to be an amount of period that can implement safety-ensured control even when the relative speeds of the self-vehicle and an oncoming vehicle and the like have been considered. In FIG. 2B, a region 221 shows the range of the local map. Note that a region 223 indicated by halftone dots shows the detection range of the LiDARs 42 and the radars 43, and a detection range 224 indicated by a lane is the detection range of the cameras 41. Note that these detection ranges need not be included in the local map 221. In the local map 221, various kinds of targets and lane divisions detected by the periphery monitoring device are shown about the self-vehicle 1 in a relative positional relationship. For example, a preceding vehicle 226 and a right-rear vehicle 225 are included as targets in the local map 221. By continuously updating this local map 221, the obstacles, the state of the road, and the like of the periphery of the self-vehicle can be referred to in real-time.

### Driving Control Apparatus

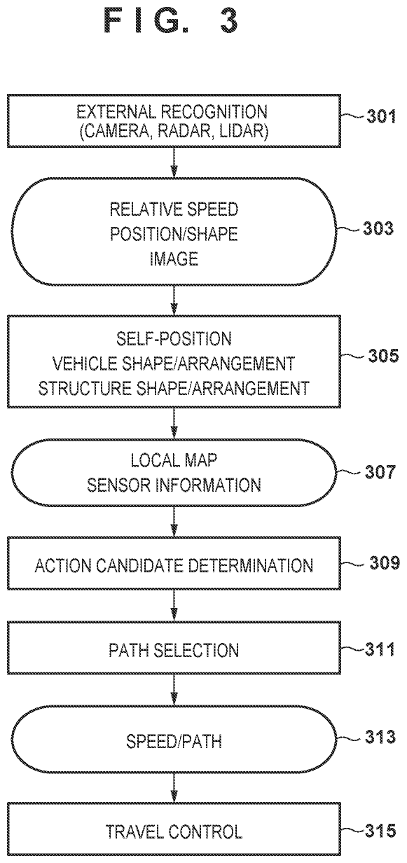

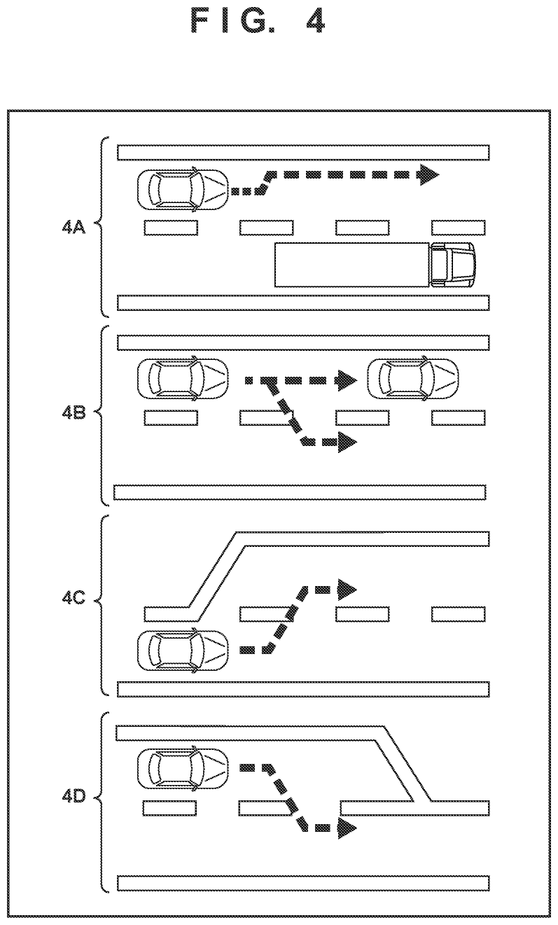

FIG. 3 shows a functional block diagram of a driving control apparatus for automated driving or driving support. This driving control apparatus is implemented by, for example, causing the ECU 20 shown in FIG. 1 to execute the procedures illustrated in FIG. 4 and subsequent drawings. As a matter of course, the procedures illustrated in FIG. 4 and subsequent drawings are merely some of the functions related to the automated driving and driving support implemented by the driving control apparatus according to this embodiment. For example, when a destination and automated driving have been instructed by a driver, the ECU 20 performs automatic control of the travel of the vehicle 1 toward the destination in accordance with the guidance route searched by the ECU 24. During automatic control, the ECU 20 obtains information related to the peripheral state of the vehicle 1 from the ECUs 22 and 23, makes instructions to the ECUs 21, 26, and 29 based on the obtained information, and controls the steering and acceleration/deceleration of the vehicle 1. FIG. 3 corresponds to a view showing the functional blocks corresponding to this procedure.

An external recognition unit 301 generates, based on external environment information indicating the state of the periphery obtained by the periphery monitoring device formed by the cameras 41, the LiDARs 42, the radars 43, and the like, information 303 that indicates, for example, the relative speed, the position, the shape, the image, and the like of a target in the periphery. Subsequently, a self-position recognition unit 305 generates a local map 307 by determining, based on the information 303, the position of the self-vehicle on the road, the shape and the arrangement about the self-vehicle of each vehicle traveling in the periphery, and the shape and the arrangement of each structure in the periphery. Note that to generate the local map 307, information such as map information that has been obtained from a device other than the periphery monitoring device may be referred in addition to the information 303. Also, in this example, in addition to the local map 307, the state of the self-vehicle such as information indicating the sensitivity of each sensor will be transferred together with the local map to an action candidate determination unit 309.

The action candidate determination unit 309 determines subsequent action candidates based on the local map 307 as an input. Action candidates are pieces of information indicating actions to be candidates for determining the action of the self-vehicle. The action to be taken by the self-vehicle is determined not only by the local map 307, but also by referring to the state of the self-vehicle in addition to the route information to the destination. The state of the self-vehicle includes, for example, the detection distance and the like of the sensors included in the periphery monitoring device. It is preferable to determine the action candidates of automated driving with some margin, for example, a couple of kilometers before the action is taken. This is because the action may not necessary be completable by automated driving, and may require a takeover operation to manual driving in such a case. For example, the self-vehicle may have to move from the lane on which it is traveling on to an adjacent lane for exiting, diverging, fueling, or the like. In such a case, if a space for entry cannot be found in the adjacent lane, a takeover operation will be performed before the point at which the lane change needs to be performed. Note that in a case in which the execution of a given action has been determined, it is preferable for the action candidate determination unit 309 not to determine the next action candidate until this action has been completed or canceled. Hence, for example, it may be arranged so that a path selection unit 311 (to be described later) will monitor whether an expected state has been achieved as a result of the selected action and notify the action candidate determination unit 309 about the achievement and cause the action candidate determination unit to determine the next action candidates. Note that this arrangement is merely an example as a matter of course.

FIG. 4 shows an example of principle actions that will be determined to be candidates. In an action 4A, when the self-vehicle is to pass a large vehicle travelling on the left lane, the self-vehicle will move to the left side while maintaining the lane. In such a movement accompanying steering to one of left and right directions in this manner, a movement that requires monitoring of a lateral direction on the movement side and on the rear side will be referred to as a lateral movement, and driving control for the lateral movement will be referred to as lateral control. In this case, the lateral directions include not only the directly lateral sides (sideways), but also the lateral sides on the front side (to be referred to as lateral front sides). The lateral front sides are, for example, the regions 214 and 215 which are the detection ranges of the LiDARs 42 and the regions 205 and 206 which are the detections of the radars 43 in FIG. 2A. The lateral movement can include a lane change, offsetting within the lane, merging, diverging, and the like. Note that travel along a curve is not included as a lateral movement in this example. This is because traveling along a road requires monitoring on only the front side. In addition, a right turn, a left turn, and the like can be further included as a lateral movement. This is because monitoring the lateral direction on the turn side and the rear side. Also, since the object of a lateral movement within the lane such as the action 4A is for reducing an oppressive feeling given to the driver, the movement is not always necessary. Thus, it need not include the margin for a takeover operation as described above. In this case, performing a lateral movement and continuing traveling without an action are the two candidates for the action to be taken. However, since it suffices to cancel the action 4A if the vehicle is in a state which is difficult to perform the lateral movement, the action of continuing traveling without an action may not be prepared as a candidate.

An action 4B of FIG. 4 is an example of an action candidate in a case in which the preceding vehicle is traveling slower than the self-vehicle. There are two options in this case. The first candidate is an action to perform preceding vehicle following travel. In terms of the level (or also referred to as the mode) of automated travel, preceding vehicle following travel is at a level in which a “hands-off” operation (in which the driver releases his/her hands from the steering wheel) is permitted. In this example, this level of travel mode will be sometimes referred to as a second mode with respect to referring to a “hands-on” operation (in which the driver grips the steering wheel) as a first mode. Also, the second candidate is an action to make a lane change to a passing lane (on the right side) while maintaining the speed to pass the preceding vehicle.

An action 4C shows a lane change by diverging. Also, an action 4D shows a lane change by merging. In these cases, the lane change will be determined as the action without an option to cancel the diverging operation as a principle if the vehicle needs to diverge from the lane due to the circumstances of the set route. However, although the lane change may be canceled for the avoidance of danger or the like, it will not be a planned action. Hence, in a case in which it is difficult to perform a lane change by automated driving, a takeover operation to the driver will need to be performed. Therefore, for example, in a case in which the vehicle is traveling by the above-described second mode, the automated driving level needs to be switched to the level equal to or lower than the first mode to prepare for the takeover operation before the diverging point or the merging point. The automated driving mode is also selected in accordance with such an action. Other than this, an action, such as a right turn, a left turn, or the like, which is to be taken at an intersection may also be determined by the action candidate determination unit 309.

Referring back to FIG. 3, the path selection unit 311 selects one action from the action candidates, as shown in FIG. 4, determined by the action candidate determination unit 309. The selected action becomes the action to be executed, and the steering, the driving, and the braking are controlled accordingly by the vehicle control apparatus. In a case in which there is only one action candidate, this only one action candidate will be selected since there are no other options. Whether which candidate will be selected among a plurality of candidates can be determined based on various kinds of references. In the example of the action 4B, it is possible to consider an arrangement in which a predetermined threshold is provided for the relative speed with respect to the preceding vehicle so an action to pass the preceding vehicle will be selected when the relative speed with respect to the preceding vehicle exceeds the threshold and an action to follow the preceding vehicle will be selected when the threshold is not exceeded. Also, in a case in which, for example, a case in which there is a diverging point in the front of the vehicle, due to the circumstances of the route to the destination, and the vehicle needs to make a lane change before (for example, within a predetermined time or within a predetermined distance of) the diverging point, a determination to perform the lane change operation earlier may be made. In either case, these cases are merely examples of the selection references, and another reference may be applied. In addition, the path selection unit 311 generates path information and speed information 313 corresponding to the selected action. The path information and speed information 313 are input to a travel control unit 315.

The travel control unit 315 controls the steering, the driving, and the braking of the vehicle based on the input path information and speed information 313. Furthermore, the steering, the driving, and the braking are controlled adaptively based on the state of an obstacle or the like in the periphery of the self-vehicle detected by the periphery monitoring device. Note that although the self-position recognition unit 305, the action candidate determination unit 309, and the path selection unit 311 can be implemented by the ECU 20, the travel control unit 315 is implemented by performing travel control by the ECUs 21, 26, 29, and the like. Processing operations by other ECUs may be included as needed as a matter of course. The travel control unit 315 may convert the path and the speed into the control amounts of actuators by using a conversion map in which, for example, the input path and the speed are associated with the respective control amounts of the actuators (including the motor and the like). Subsequently, travel control is performed by using the converted control amounts.

### Action Candidate Determination and Path Selection Processing

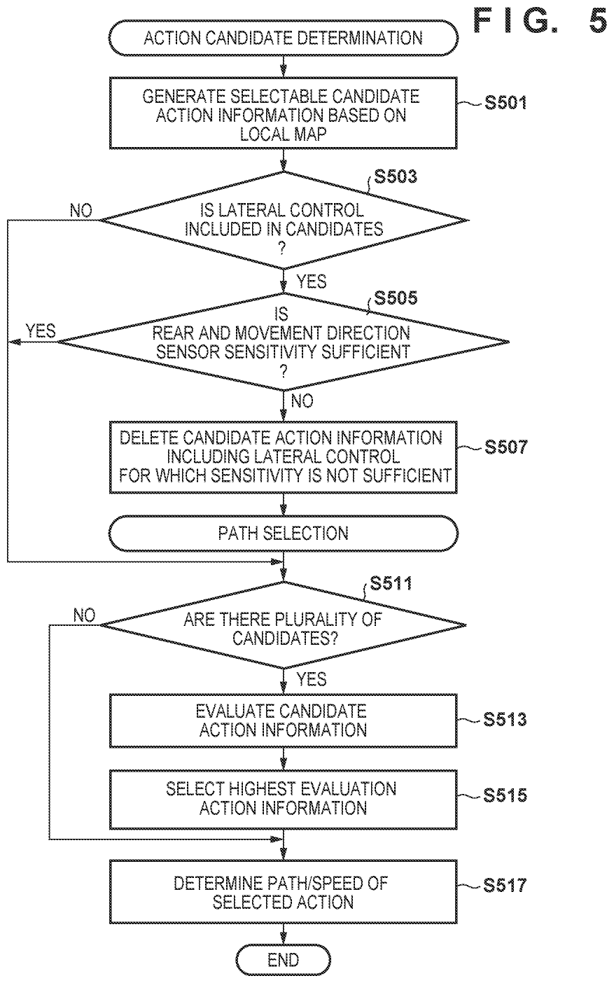

FIG. 5 partially shows the respective processing operations to be executed by the action candidate determination unit 309 and the path selection unit 311. Since these processing operations are executed by the ECU 20 as previously described, the procedure shown in FIG. 5 is processing to be executed by the ECU 20. The action candidate determination unit 309 generates, based on the local map 307, selectable action candidates (step S501). Since the action candidate determination unit will generate data or information indicating an action, these action candidates will be also referred to as pieces of candidate action information. Although the details of the generation process will be omitted, for example, candidate information as described with reference to FIG. 4 is generated in accordance with the peripheral environment of the vehicle 1. In addition, together with each action candidate, the automated driving mode (level) of the action may also be determined. Next, the action candidate determination unit 309 determines (step S503) whether action information which requires lateral control is included among the pieces of candidate action information that have been generated. In this embodiment, lateral control is control for a lateral movement as described above. As described above, a lateral movement is, among movements accompanying steering to one of left and right directions in this manner, a movement which requires monitoring of a lateral direction on the movement side and on the rear side. The lateral movement does not include travel along a curve, but includes a right turn and a left turn. In a case in which it is determined that the generated pieces of candidate action information do not include the action information which requires lateral control, the process advances to the processing by the path selection unit 311. On the other hand, in a case in which it is determined that the action information requiring lateral control is included, whether the sensitivity of each rear sensor and the sensitivity of each lateral, in particular horizontal movement, movement direction sensor are sufficient will be determined (step S505).

In this case, the rear sensors correspond to the LiDAR 42 whose normal detection range is the region 212 and the radars 43 whose normal detection ranges are the regions 202 and 203, respectively, in FIG. 2A. Also, the lateral movement direction sensors correspond to the sensors present on the movement direction side (right or left) among the LiDARs 42 whose normal detection ranges are the regions 211, 213, 214, and 215. In a similar manner, the lateral movement direction sensors correspond to the sensors present on the movement direction side (right or left) among the radars 43 whose normal detection ranges are the regions 201, 204, 205, and 206. The sensitivity, that is, the detection distance and/or the detection range of each sensor can be determined by comparing, for example, the detection results of sensors whose normal detection ranges are an overlapping region. Also, a self-diagnosis circuit (not shown) can electronically determine the sensitivity of each sensor based on an output signal or the like from the sensor. In addition, the sensitivity of each sensor can be measured by measuring the intensity of the detection signal or the like by targeting a target whose distance is known. Furthermore, a state in which the sensitivity is sufficient is a state in which the detection distance which is the detectable distance is equal to or more than a predetermined distance. In addition, a state in which the detection range is equal to or more than a predetermined range may also be added as a condition. The sensitivity of each sensor will also be referred to as a detection level, and it can be said that a state with a sufficient sensitivity is a state in which the detection level has reached a predetermined level.

That is, a state in which the sensitivity of each rear sensor is sufficient is a state in which the detection level of the LiDAR 42 whose detection range is the region 212 has received a predetermined level or a state in which the detection levels of the radars 43 whose detection ranges are the region 202 and the region 203, respectively, have reached a predetermined level. However, since the radars 43 have two sensors as the rear sensors, it may be determined that the sensitivity is sufficient when the detection levels of both sensors have reached the predetermined level. Alternatively, it may be determined that the sensitivity is sufficient when the detection level of the rear sensor on the lateral movement direction side has reached a predetermined level. In a similar manner, a state in which the sensitivity of each lateral sensor is sufficient is a state in which the detection levels of the LiDARs 42 whose detection ranges are the region 211, the region 213, the region 214, and the region 215 have reached a predetermined level or a state in which the detection levels of the radars 43 whose detection ranges are the region 201, the region 204, the region 205, and the region 206 have reached a predetermined level. However, the lateral side need not be both the left and right lateral sides, but may be restrictively interpreted as indicating the lateral movement direction. In this case, it may be determined that the sensitivity is sufficient if the detection level of the lateral sensor on the latera movement direction side has reached the predetermined level.

In a case in which it is determined that the rear and the movement direction sensor sensitivities are not sufficient, the candidate action including lateral control is deleted from the candidate actions (step S507). However, if the sensitivities of the lateral sensors in the lateral movement direction and the rear sensors are sufficient, the candidate action including lateral control for a lateral movement need not be deleted. For example, if the sensitivities of the right lateral sensors and the rear sensors are sufficient, the candidate action information including a right movement need not be deleted even if the sensitivities of the left lateral sensors are insufficient.

When the action candidates have been generated in this manner, the process next shifts to the path selection processing by the path selection unit. First, the path selection unit determines whether there are a plurality of action candidates. If there is only one action candidate, the path selection unit selects the candidate as the next action and determines the path and speed information of this action (step S517). On the other hand, if there are a plurality of action candidates, the path selection unit selects one of the action candidates. Hence, the path selection unit will evaluate the candidate action information of each action candidate (step S513). Subsequently, the path selection unit selects (step S515) the action candidate with the highest evaluation as the next action, and determines the path and speed information of this action (step S517). The path information and speed information generated in this manner are input to the travel control apparatus (alternatively, the travel control unit), and the selected action is implemented by controlling the travel by the corresponding path and speed. In a case in which the travel control apparatus is formed by a plurality of ECUs, each ECU will control the corresponding control target actuator in accordance with the determined path and speed.

In this case, the evaluation target in step S513 may vary in accordance with the state as described in FIG. 4. For example, in the example of the lane change in the action 4B, the evaluation reference is based on a speed difference; an evaluation may be performed by adding a point to a lane change evaluation point if the relative speed with respect to the preceding vehicle is equal to or more than a threshold and adding a point to a lane maintenance evaluation point if otherwise. If there is another evaluation target, this target will also be evaluated, and an action with the higher comprehensive evaluation point will be selected. Alternatively, each action may be evaluated by focusing on one aspect of the action, and this evaluation may be performed on several aspects to make a comprehensive determination. For example, in the aforementioned example, an evaluation can be performed on the aspect of the required time; a point is added to an action for passing the preceding vehicle if the speed difference is equal to or more that predetermined value and a point is not added to any of the actions if the required time is less than a predetermined value. Furthermore, an evaluation may be performed by executing an evaluation from the aspect of fuel economy, and a point may be added to an action that can travel at a speed with good fuel economy. Also, it may be arranged so that a point will be added to an action that raises the automated driving level, not be added to an action that maintains the automated driving level, and be decreased from an action that lowers the automated driving level. These evaluation methods are merely examples as a matter of course, and another evaluation method may be employed. Note that although the action candidate determination unit 309 performs the suppression the lateral control based on the sensor sensitivity in FIG. 5, the path selection unit 311 may perform this suppression operation in steps S503 to S507.

The action taken during travel is determined and implemented in the above described manner. In this example, the latera control is suppressed in a case in which at least one of the detection levels of the lateral and rear sensors does not reach a predetermined level. The lateral control is not suppressed and the lateral movement can be selected in a case in which the detection levels of both of the lateral and rear sensors have reached the predetermined level. As a result, the risk of the self-vehicle can be reduced by executing the lateral control only when not only the lateral side, but also the rear lateral sides can be detected.

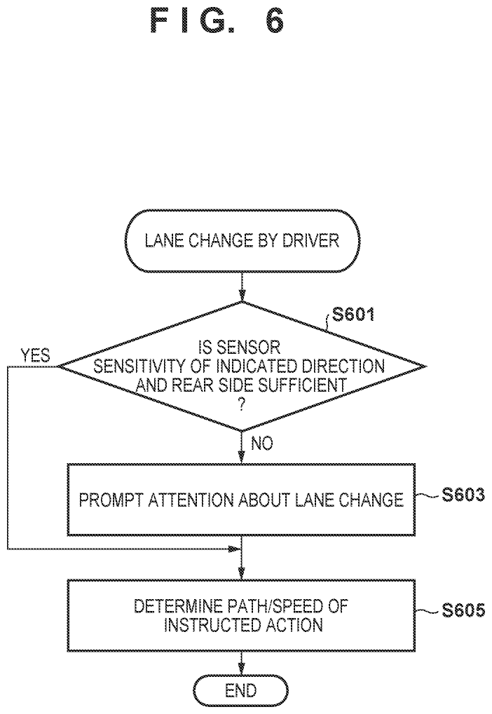

Processing performed by the path selection unit 311 in a case in which a driver has made a lane change instruction during automated driving will be described next with reference to FIG. 6. The procedure of FIG. 6 is executed, for example, when the driver has operated the direction indicator while lane maintenance travel is being continued by automated driving. First, the path selection unit determines whether the sensitivities of both the lateral sensor and the rear sensor in the indicated direction are sufficient. This determination reference may be similar to that in the process of step S505. If it is determined to be insufficient, the path selection unit prompt the driver's attention about the lane change to the instructed side (step S603), and determines the path information and the speed information of the lane change as the instructed action (step S605). Subsequently, travel control by the travel control unit is executed. On the other hand, if it is determined that the sensor sensitivities on the instructed side are sufficient, the process of step S603 is skipped, and the path information and the speed information of the lane change as the instructed action are determined (step S605). In this manner, in the case of a lane change requested by the vehicle control apparatus in automated driving as shown in FIG. 5, if the sensitivities of both the lateral sensor and the rear sensor in the indicated direction are not sufficient, this action will be suppressed. On the other hand, in the case of a lane change requested by the driver, although the driver's attention will be prompted if the sensitivities of both the lateral sensor and the rear sensor in the indicated direction are not sufficient, the lane change will not be suppressed and will be directly performed. Note that in a case in which automated driving is being performed by the second mode which allows the hands-off operation before the lane change, it is preferable to change the automated driving level to the first mode together with the attention prompting operation performed in step S603.

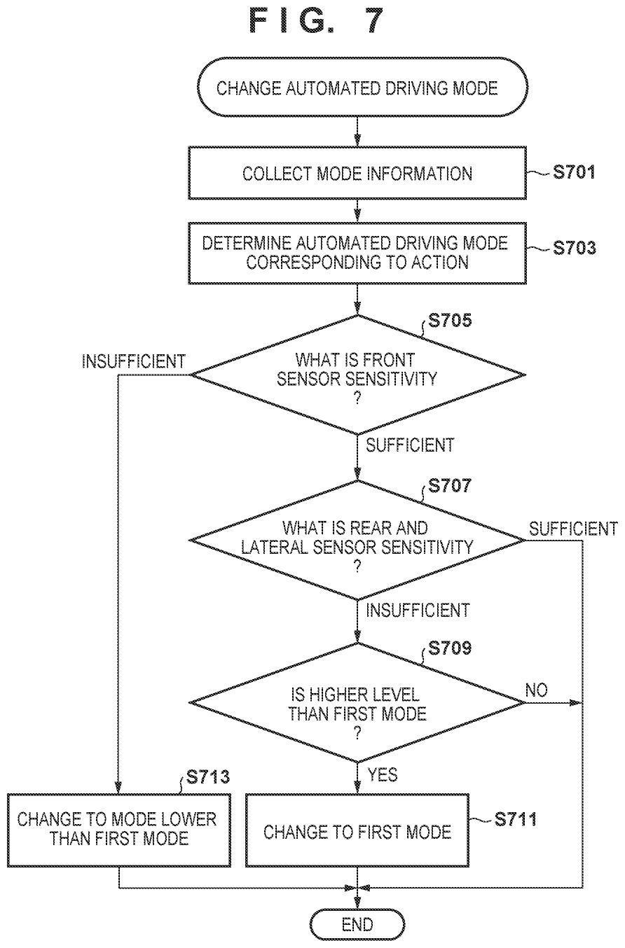

The processing of changing the automated driving mode will be described next with reference to FIG. 7. The procedure of FIG. 7 may be executed by, for example, the action candidate determination unit 309 together with the determination of the action candidates in the process of step S501, and a mode corresponding to the action may be determined. This procedure may be executed by the ECU 20 in terms of the hardware arrangement shown in FIG. 1.

First, mode information necessary for determining the mode is collected (step S701). Since the procedure of FIG. 7 is to be performed by the action candidate determination unit 309 in this example, a local map and the state information of the self-vehicle including the detection distances of the sensors forming the periphery monitoring device are used as the mode information. Subsequently, a mode with the highest automation rate among the automated driving modes corresponding to the action candidate is determined to be the mode (step S703). In a case in which there are a plurality of candidates, the mode is determined in accordance with each candidate, as a matter of course.

Next, the action candidate determination unit will determine whether the sensitivities of the front sensors are sufficient (step S705). Of the detection ranges shown in FIG. 2A, the front sensors are the sensors in charge of the detection ranges, of the LiDARs 42 and radars 43, at the front of the vehicle excluding the detection ranges 201 to 204 and 211 to 213. For example, it may be the radar 43 in charge of the region 207 and the like. Furthermore, the front lateral detection ranges 205, 206, 214, and 215 may be concurrently regarded as those of the front sensors as well as those of the lateral sensors. The cameras 41 may be included in a case in which the cameras 41 are used to detect the distance and the range to a target. Also, the sensor sensitivities are similar to those described in the processes of step S505 and the like. If the sensitivities of the front sensors are determined to be insufficient in step S705, the mode determined in step S703 is changed to a mode which is lower than the first mode (step S713). Note that a state in which the sensitivities of the front sensors are sufficient (that is, the detection levels have reached a predetermined level) is more specifically a state in which the sensitivities of both the radar 43 in charge of the region 207 and the cameras 41 are sufficient. In other words, if the sensitivity of one of the radar 43 in charge of the region 207 and the cameras 41 is insufficient or defective, the sensitivities of the front sensors will be determined to be insufficient. In this manner, one of the first mode and the manual mode is selected in accordance with the types and the numbers of sensors that can perform detection, that is, the sensors with sufficient sensitivities. The selection method is not limited to the example described above. The combination of sensors to be determined to have sufficient sensitivities or the combination of sensors to be determined to have insufficient sensitivities may be determined in advance. In other words, a case in which the sensitivities are not determined to be sufficient can be regarded as a case in which the sensitivities are insufficient (that is, the detection levels have not reached a predetermined level). The first mode is a mode in which the driver is requested to perform the hands-on operation. A mode which is lower than the first mode includes, for example, the manual driving mode. In a case in which the mode is changed to a mode which is lower than the first mode in this procedure, the action corresponding to the mode may need to be changed in some cases. For example, if the mode after the change is the manual driving mode, all of the determined action candidates will be canceled, and a takeover notification will be issued to the driver.

On the other hand, in a case in which it is determined in step S705 that the sensitivities of the front sensors are sufficient, whether the sensitivities of the rear sensors and the lateral sensors are sufficient (step S707). This determination can be similar to that performed in step S505. If the sensitivities are determined to be sufficient in step S707, the mode determined in step S703 is maintained without any change. If the sensitivities are determined to be insufficient, it will be determined whether the mode determined in step S703 is a mode (also referred to as a mode of a higher level than the first mode) with a higher automation rate than the first mode (step S709). This mode includes the second mode in which the driver does not need to grip (hands-off) the steering wheel. If the mode determined in step S703 is a mode of a higher level than the first mode, this mode is changed to the first mode (step S711). No change is necessary if the mode determined in step S703 is the first mode. Also, if it is determined that the mode determined in step S703 is a mode with a lower automation rate than the first mode, this mode will be maintained.

Note that in a case in which the automated driving mode is to be changed from the second mode to the first mode, the action itself may be maintained. The difference between the first mode and the second mode is whether periphery monitoring by the driver is required, and a state in which the driver is gripping the steering wheel is a premise of the first mode even in the same action (vehicle control). Thus, in a case in which the vehicle control of the system matches the actual environment and the driver, the function can be directly continued in a state in which the driver's hands have been placed on the steering wheel, and the driver can continue to receive the benefits of automation. On the other hand, if different driving operations are temporarily performed by the system and the driver, it can allow the driver to immediately intervene in the driving because the driver is gripping the steering wheel. Hence, the action need not be particularly deleted or changed based on this point as a difference.

When the action to be taken is selected by the path selection unit 311, the mode shifts to the driving mode corresponding to the selected action, and the travel control for the selected action is continued. That is, the automated driving mode determined by the procedure of FIG. 7 will be set. As a result, if the sensitivities of the front sensors are insufficient, both the first mode and the second mode will be suppressed. If the sensitivities of the front sensors are sufficient, the transition to the first mode will not be suppressed even if the sensitivities of one of the rear sensors and the lateral sensors is not sufficient.

As described above, a vehicle control apparatus according to this embodiment partially suppresses the action of automated driving and some of the automated driving modes in accordance with the state of the sensors of the periphery monitoring device included in the vehicle. As a result, it is possible to ensure the safety in automated driving and implement vehicle control in which the condition required for automated driving will not be narrowed more than necessary. The embodiment will be summarized below.

### Summary of Embodiment

The above-described embodiment is summarized as follows.

(1) The first mode of the embodiment is a vehicle control apparatus characterized by comprising:

periphery monitoring means (41, 42, 43) for performing periphery monitoring of a self-vehicle; and

vehicle control means (20-29) for performing travel control including steering control based on an output from the periphery monitoring means,

wherein the periphery monitoring means of the self-vehicle can detect a target on each of a lateral side and a rear side of the self-vehicle,

does not suppress the lateral control in a case in which each of detection levels of both the lateral side and the rear side has reached a predetermined level, and

suppresses the lateral control, which is accompanied by the steering control, in a case in which the detection level of at least one of the lateral side and the rear side has not reached the predetermined level.

According to this arrangement, it is possible to reduce the risk of the self-vehicle by performing lateral control in a state in which detection is being performed not only on the lateral side, but also on the rear lateral side. In this case, lateral control points to an operation to suppress a lane change and offset travel with respect to the white line as a center.

(2) The second mode of the embodiment is a vehicle control apparatus characterized in that, in addition to the first mode, the lateral control includes

steering control performed within a lane on which the self-vehicle is traveling,

a lane change (a lane change, passing, diverging, or merging with respect to a destination), and

a course change (right or left turn) at an intersection.

According to this arrangement, it is possible to suppress the risk generation with another vehicle due to lateral control of the self-vehicle without restricting an action along a curve even in the lateral control.

(3) The third mode of the embodiment is a vehicle control apparatus characterized in that, in addition to the first mode or the second mode, the lateral control includes a driver lane change based on a request from a driver, and

a system lane change based on a request from the vehicle control means, and

in a case in which the detection levels of both the lateral side and the rear side of the periphery monitoring means are not less (better) than a predetermined detection level, the system lane change and the driver lane change are not suppressed, and

in a case in which the detection levels of both the lateral side and the rear side of the periphery monitoring means are lower (worse) than the predetermined detection level, the system lane change is suppressed, but the driver lane change is not suppressed.

According to this arrangement, it is possible to provide driving support that is currently possible while ensuring safety because a driver request can be issued under a state in which monitoring is being performed by the driver.

(4) The fourth mode of the embodiment is a vehicle control apparatus characterized in that, in addition to the first to the third modes, the periphery monitoring means can detect a target on a front side, the rear side, and the lateral side of the self-vehicle, and

includes, as a mode of one of automated driving and driving support, a first mode (hands-on) and a second mode (hands-off) which has one of a higher automation rate and a higher number of reduced tasks requested to the driver than the first mode,

wherein in a case in which the detection level of at least one of the lateral side and the rear side does not reach the predetermined level, the second mode is suppressed without suppressing the first mode, and

in a case in which the detection level of the front side does not reach the predetermined level, the first mode and the second mode are suppressed.

According to this arrangement, all modes will be prohibited when the front side cannot be detected, and some modes will be permitted when the rear side and the lateral side are not visible.

(5) The fifth mode of the embodiment is a vehicle control apparatus characterized in that, in addition to the first to the fourth modes, the lateral side includes lateral sides on a left side and on a right side, and in a case in which the detection level of one of the left side and the right side has not reached the predetermined level and the detection level of the rear side has reached the predetermined level, the lateral control to be performed on the side in which the detection level has not reached the predetermined level is suppressed.

According to this arrangement, it is possible to prevent a state in which the margin of automated driving is reduced more than necessary by further narrowing the condition in which lateral control will be suppressed.

The present invention is not limited to the above-described embodiments, and various changes and modifications can be made within the spirit and scope of the present invention. Therefore, to apprise the public of the scope of the present invention, the following claims are made.

1. A vehicle control apparatus for controlling a vehicle, comprising:
a periphery monitoring unit for performing periphery monitoring of the vehicle; and
a vehicle control unit for performing travel control including steering control based on an output from the periphery monitoring unit,
wherein the periphery monitoring unit can detect a target on each of a lateral side and a rear side of the vehicle, and
the vehicle control unit does not suppress the lateral control in a case in which each of detection levels of both the lateral side and the rear side has reached a predetermined level, and
suppresses the lateral control, which is accompanied by the steering control, in a case in which the detection level of at least one of the lateral side and the rear side has not reached the predetermined level, and
wherein the lateral control includes a driver lane change in which the vehicle control unit subjectively performs the travel control including the steering control based on a request from a driver, and a system lane change in which the vehicle control unit subjectively performs the travel control including the steering control based on a request from the vehicle control unit, and
in a case in which each of the detection levels of both the lateral side and the rear side of the periphery monitoring unit is not less than the predetermined level, the system lane change and the driver lane change are not suppressed, and
in a case in which each of the detection levels of both the lateral side and the rear side of the periphery monitoring unit is lower than the predetermined detection level, the system lane change is suppressed, but the driver lane change is not suppressed.

2. The vehicle control apparatus according to claim 1, wherein the lateral control includes
steering control performed within a lane on which the self-vehicle is traveling,
a lane change, and
a course change at an intersection.

3. The vehicle control apparatus according to claim 1, wherein the periphery monitoring unit can detect a target on a front side, the rear side, and the lateral side of the vehicle, and
modes of one of automated driving and driving support includes a first mode and a second mode which has one of a higher automation rate and the higher number of reduced tasks requested to the driver than the first mode,
wherein in a case in which the detection level of at least one of the lateral side and the rear side does not reach the predetermined level, the second mode is suppressed without suppressing the first mode, and
in a case in which the detection level of the front side does not reach the predetermined level, the first mode and the second mode are suppressed.

4. The vehicle control apparatus according to claim 1, wherein the lateral side includes one of a left side and a right side, and in a case in which the detection level of one of the left side and the right side has not reached the predetermined level and the detection level of the rear side has reached the predetermined level, the lateral control to be performed on the side in which the detection level has not reached the predetermined level is suppressed.

5. The vehicle control apparatus according to claim 1, wherein, the peripheral monitoring unit includes a plurality of types of periphery monitors, and
a driving support corresponding to a combination of the periphery monitors that have sensitivities which do not reach the predetermined level among a plurality of driving support modes is suppressed.
